(19) United States
(12) Patent Application Publication
(10) Pub. No.: US 2024/0079982 A1
(43) Pub. Date: Mar. 7, 2024

(54) Power Converter Apparatus

(71) Applicant: Hitachi Industrial Equipment Systems Co., Ltd., Chiyoda-ku, Tokyo (JP)

(72) Inventors: Kazuaki TOBARI, Tokyo (JP); Hironori OHASHI, Tokyo (JP); Hiroshi WATANABE, Tokyo (JP); Masato OHYA, Tokyo (JP)

(21) Appl. No.: 18/273,844

(22) PCT Filed: Nov. 10, 2021
(86) PCT No.: PCT/JP2021/041409

§ 371 Date: Jul. 24, 2023

(30) Foreign Application Priority Data
Jun. 29, 2021 (JP) 2021-107665

(51) Int. Cl. H02P 21/26; H02P 21/14; H02P 21/22

(52) U.S. Cl. CPC H02P 21/26; H02P 21/141; H02P 21/22

(57) ABSTRACT

A power converter apparatus comprising: a power converter that outputs signal to the magnet motor to vary the output frequency, output voltage and output current of the magnet motor, a control unit controls the power converter, wherein the control unit calculating the gain of the magnetic flux component of the q-axis, which varies with the phase of the magnet motor, calculating the d-axis induced voltage command value based on a value of the induced voltage coefficient, frequency estimates or frequency command value, and the gain of the flux component of the q-axis.

### TECHNICAL FIELD

This invention relates to a power converter apparatus.

### BACKGROUND ART

When the magnet motor induced voltage has superimposed 5th and 7th order components of the fundamental frequency, the controller's memory stores magnet motor induced voltage data, and based on the angular frequency ω and rotation position θ, d-axis and q-axis induced voltage command values are generated based on the angular frequency ω and rotational position θ, and the control technique to make the current sinusoidal is described in Patent Document 1.

### CITATION LIST

### Patent Document

Patent Documents 1 Patent Publication No. 2003-199390

### SUMMARY OF THE INVENTION

### Problems to be Solved by the Invention

In Patent Document 1, it is necessary to store magnet motor induced voltage data in the controller's memory. However, when the induced voltage is a square wave, current pulsation due to odd components (11th, 13th, 17th, 19th, 23rd, 25th . . . ) excluding multiples of 3 of the harmonic components may occur. The generation of current pulsation is possible.

The purpose of this invention is to provide a power converter apparatus that makes the magnet motor current sinusoidal without having induced voltage data.

One preferred example of the invention is a power converter apparatus comprising a power converter that outputs signal to the magnet motor to vary the output frequency, output voltage and output current of the magnet motor, a control unit controls the power converter, wherein the control unit calculating the gain of the magnetic flux component of the q-axis, which varies with the phase of the magnet motor, calculating the d-axis induced voltage command value based on a value of the induced voltage coefficient, frequency estimates or frequency command value, and the gain of the flux component of the q-axis.

### Effects of the Invention

According to this invention, the current of magnet motor can be sinusoidal without having induced voltage data.

### BRIEF DESCRIPTION OF DRAWINGS

FIG. 1: System configuration diagram of the power converter apparatus and other equipment in Example 1.

FIG. 2: Configuration diagram of the magnetic flux gain calculation unit in Example 1.

FIG. 3: Configuration diagram of the vector control arithmetic unit in Example 1.

FIG. 4: Control characteristics 1.

FIG. 5: Configuration diagram of the q-axis magnetic flux gain calculation unit (N=4) in the example.

FIG. 6: Configuration diagram of the magnetic flux gain calculation unit (N=4) for the d-axis in Example 1.

FIG. 7: Control characteristics 2.

FIG. 8: Configuration diagram of the q-axis magnetic flux gain calculation unit (N=1) in Example 1.

FIG. 9: Configuration diagram of the magnetic flux gain calculation unit (N=1) for the d-axis in Example 1.

FIG. 10: Control characteristic 3.

FIG. 11: Configuration diagram for checking the manifestation of the invention.

FIG. 12: System configuration diagram of the power converter apparatus and other equipment in Example 2.

FIG. 13: System configuration diagram of the power converter apparatus and other equipment in Example 3.

FIG. 14: System configuration diagram of the power converter apparatus and other equipment in Example 4.

### MODE FOR CARRYING OUT THE INVENTION

The following drawings are used to explain this example in detail. The same reference numbers are used for common configurations in each figure. The examples described below are not limited to the illustrated examples.

### EXAMPLE 1

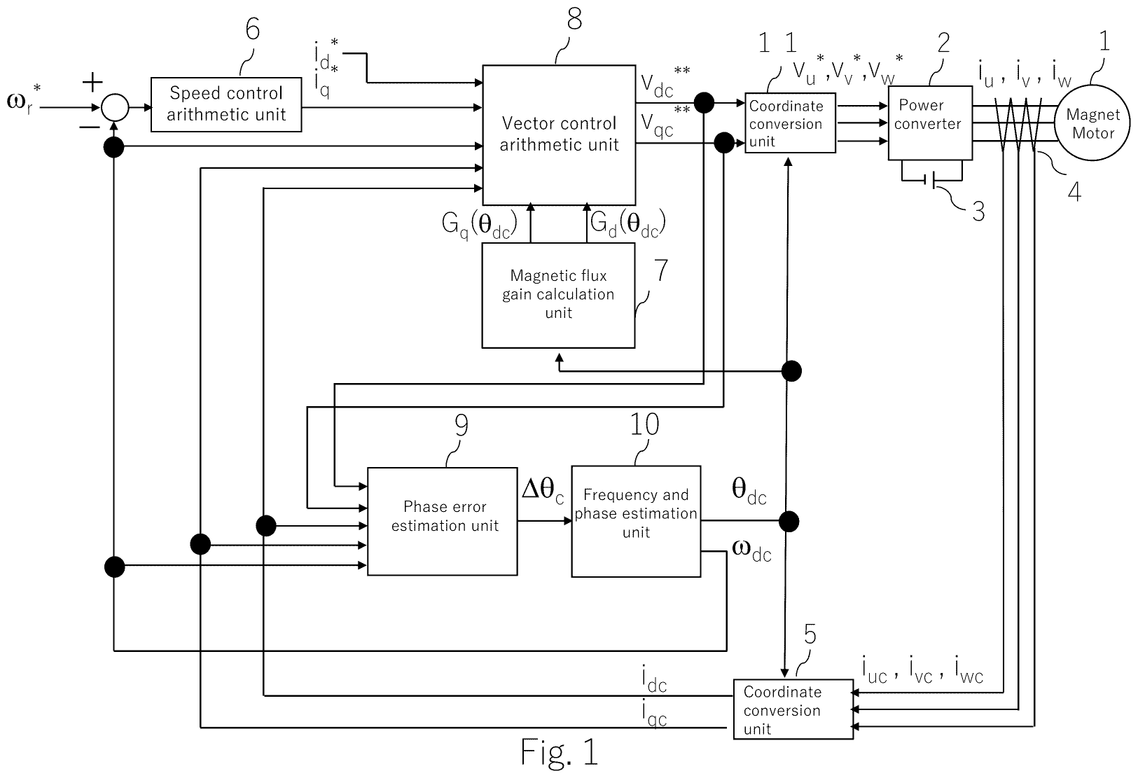

FIG. 1 shows a system configuration diagram with power converter apparatus and magnet motor in Example 1.

Magnet motor 1 outputs motor torque that is a composite of the torque component due to the magnetic flux of the permanent magnet and the torque component due to the inductance of the armature winding.

Power converter 2 is equipped with semiconductor devices as switching elements. Power converter 2 inputs 3-phase AC voltage command value vᵤ*, vᵥ*, v_{w}* and outputs voltage values proportional to 3-phase AC voltage command value vᵤ*, vᵥ*, v_{w}* based on the output of power converter 2, magnet motor 1 is driven, and the output voltage value, output frequency value, and output current value of magnet motor 1 are controlled variably. IGBT (Insulated gate bipolar transistor) may be used as switching elements.

DC power supply 3 supplies DC voltage and DC current to power converter 2.

The current detector 4 outputs i_{uc}, i_{vc}, and i_{wc}, which are the detected values of the alternating current iᵤ, iᵥ, and i_{w} of the three phase magnet motor 1. The current detector 4 detects the alternating current of two of the three phase magnet motor 1, for example, phase u and phase w. The alternating current of phase v may be calculated from the AC condition (iᵤ+iᵥ+i_{w}=0) to be iᵥ=−(iᵤ+i_{w}).

In this example, the current detector 4 is shown in the power converter apparatus, but it can also be located outside the power converter apparatus.

The control unit is equipped with a coordinate conversion unit 5, speed control arithmetic unit 6, magnetic flux gain calculation unit 7, vector control arithmetic unit 8, phase error estimation unit 9, frequency and phase estimation 10, and coordinate conversion unit 11 described below. Unit 8, phase error estimation unit 9, frequency and phase estimation 10, and coordinate conversion unit 11.

The control unit controls the output of power converter 2 so that the output voltage value, output frequency value, and output current of magnet motor 1 are controlled variably.

The control unit is composed of microcomputers and semiconductor integrated circuits (arithmetic and control means) such as DSP (digital signal processor), etc. Any or all of the control unit can be composed of hardware such as ASIC (Application Specific Integrated Circuit) and FPGA (Field Programmable Gate Array).

The CPU (Central Processing Unit) of the control unit reads the program stored in the memory or other recording device and executes the processing of each part of the coordinate conversion unit 5 and other parts described above.

Next, each component of the control unit is explained. Coordinate conversion unit 5 outputs current sense values i_{dc} and i_{qc} for the d- and q-axes from the three-phase alternating current iᵤ, iᵥ, i_{w} detection values i_{uc}, i_{vc}, i_{wc} and phase estimate value θ_{dc}.

The speed control arithmetic unit 6 calculates the torque command value τ* based on the frequency command value ωᵣ* and frequency estimates ω_{dc} and divides it by the torque coefficient to output the q-axis current command value i_{q}*

The magnetic flux gain calculation unit 7 outputs the gains G_{d} (q_{dc}) and G_{q} (q_{dc}) of the d-axis and q-axis magnetic flux components that vary with phase based on the phase estimate value θ_{dc}

The vector control arithmetic unit 8 outputs current command value i_{d}*, i_{q}*, current sense value i_{dc}, i_{qc}, frequency estimates ω_{dc} of the d-axis and q-axis, the electrical circuit parameters of magnet motor 1 and voltage command value v_{dc}** and v_{qc}** are calculated based on the gains G_{d} (q_{dc}) and G_{q} (q_{dc}) of the magnetic flux components of the q-axis and d-axis.

The phase error estimation unit 9 outputs the estimated phase error Δθ_{c}, which is the deviation between the phase estimate value θ_{dc}, which is the phase of the control, and the phase θ_{d} of the magnet motor 1 by using the control axis d-axis and q-axis voltage command value v_{dc}**, v_{qc}**, frequency estimates ω_{dc}, current sense value i_{dc}, i_{qc} and electrical circuit parameters of magnet motor 1.

The frequency and phase estimation 10 outputs the frequency estimate ω_{dc} and phase estimate value θ_{dc} based on the phase error estimates Δθ_{c}

Coordinate conversion unit 11 outputs 3-phase AC voltage command value vᵤ*, vᵥ*, and v_{w}* from d-axis and q-axis voltage command value v_{dc}** and v_{qc}** and phase estimate value θ_{dc}.

First, the basic operation of the sensor-less vector control system when using the magnetic flux gain calculation unit 7, which is a feature of this example is described.

The speed control arithmetic unit 6 calculates the torque command τ* and the current command value i_{q}* of the q-axis according to Formula 1 by proportional and integral control so that the frequency estimates ω_{dc} follow the frequency command value ωᵣ*.

$$\begin{matrix}[ Formula 1 ] & \\ \begin{matrix}{τ}^{*} = ( {ω}_{r}^{*} - {ω}_{d c} ) ( {K}_{sp} + \frac{{K}_{si}}{s} ) \\ {i}_{q}^{*} = \frac{{τ}^{*}}{3 / 2 {P}_{m} [ {K}_{e}^{*} + ( {L}_{d}^{*} - {L}_{q}^{*} ) {i}_{d}^{*}}\end{matrix} ) & ( 1 )\end{matrix}$$

### WHEREAS,

Kₛₚ: proportional gain of speed control, Kₛᵢ: integral gain of speed control, Pₘ: polar logarithm,
Kₑ: Induced voltage coefficient, L_{d}: d-axis inductance,
L_{q}: q-axis inductance,
*:set value, s is Laplace operator

The magnetic flux gain calculation unit 7 and vector control arithmetic unit 8 in FIG. 1 are explained.

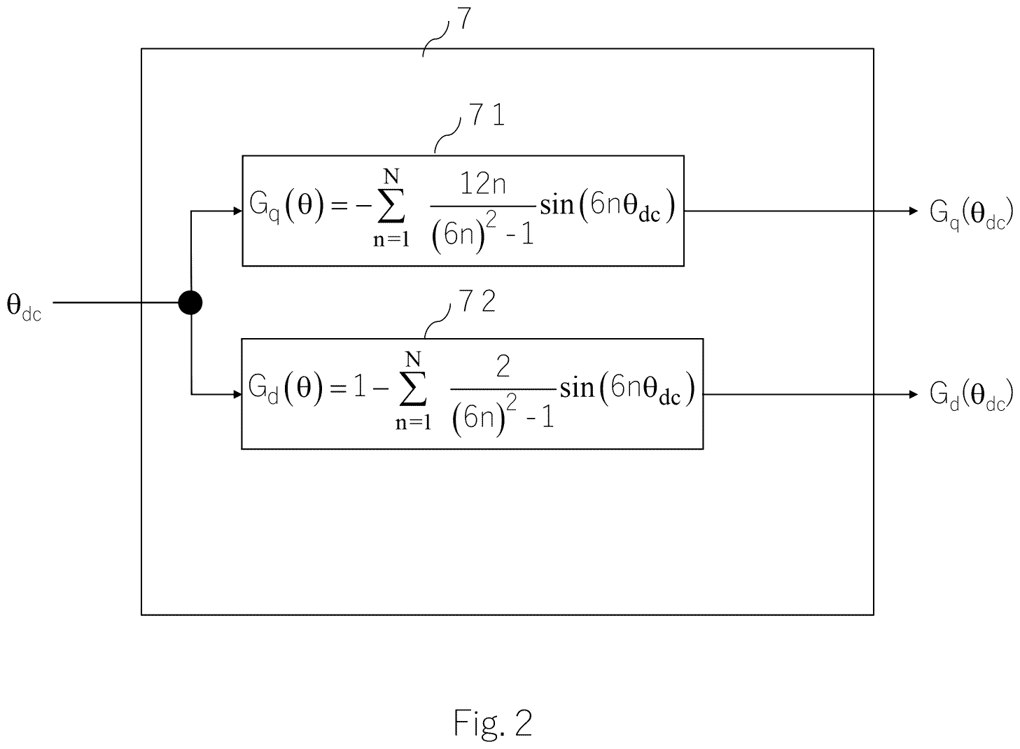

FIG. 2 shows the block diagram of the magnetic flux gain calculation unit 7, which consists of the q-axis magnetic flux gain calculation unit 71 and the d-axis magnetic flux gain calculation unit 72, flux gain calculation unit 72 for the d-axis.

The q-axis magnetic flux gain calculation unit 71 calculates the sine function of the phase estimate according to Formula 2 using the phase estimate value θ_{dc} and outputs the q-axis magnetic flux gain G_{q} (θ_{dc}).

$$\begin{matrix}[ Formula 2 ] & \\ {G}_{q} ( {θ}_{d c} ) = - {\sum }_{n = 1}^{N} \frac{12 n}{{( 6 n )}^{2} - 1} sin ( 6 n {θ}_{d c} ) & ( 2 )\end{matrix}$$

The magnetic flux gain calculation unit 72 of d-axis calculates the sine function of the phase estimate according to Formula 3 using the phase estimate value θ_{dc} and outputs the magnetic flux gain G_{q} (θ_{dc}) of d-axis. N is the order and a natural number.

$$\begin{matrix}[ Formula 3 ] & \\ {G}_{d} ( {θ}_{d c} ) = 1 - {\sum }_{n = 1}^{N} \frac{2}{{( 6 n )}^{2} - 1} sin ( 6 n {θ}_{d c} ) & ( 3 )\end{matrix}$$

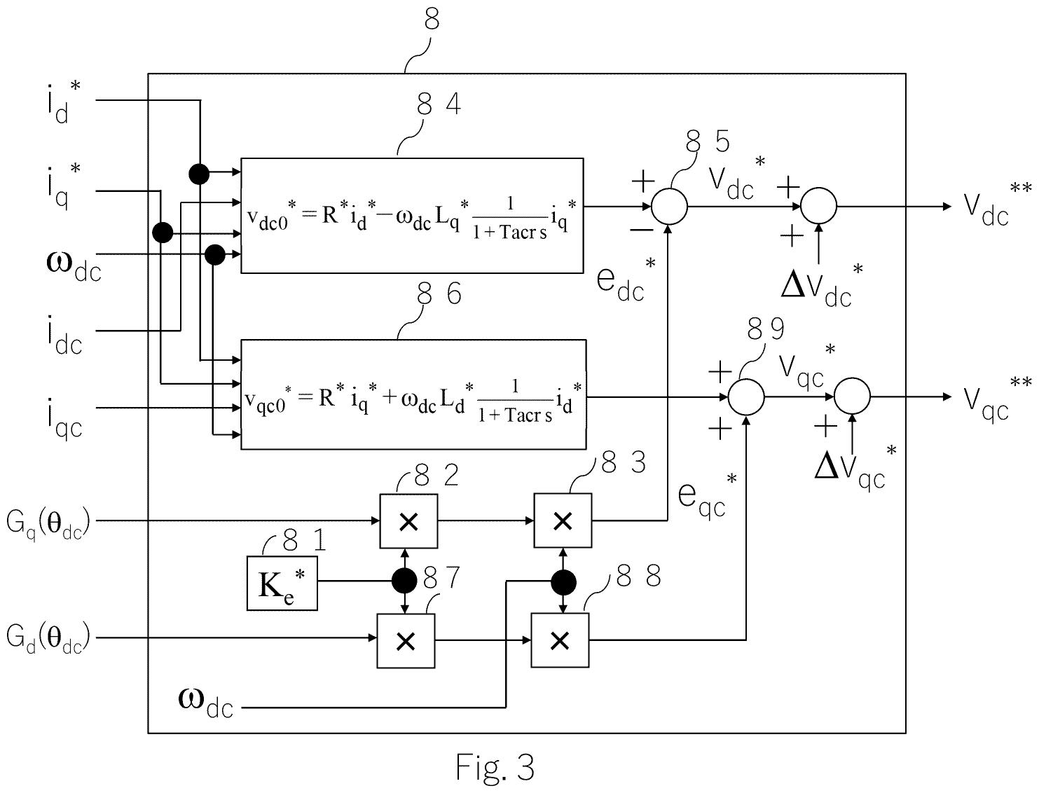

FIG. 3 shows the block diagram of vector control arithmetic unit 8. First, the d-axis voltage command value of vector control arithmetic unit 8 is explained.

The permanent magnet motor 1 induced voltage coefficient Kₑ* 81 and q-axis magnetic flux gain G_{q} (θ_{dc}) are input to multiplier 82.

The output of multiplier 82 is input to multiplier 83 together with frequency estimates ω_{dc} and its output is d-axis induced voltage command value e_{dc}* shown in Formula 4.

Here, frequency estimates ω_{dc} is used as the input to multiplier 83, but it can be modified so that instead of frequency estimates ω_{dc}, frequency command value ωᵣ* is used as the input to multiplier 83 and multiplied with the output of multiplier 82.

[Formula 4]

e_{dc}*=ω_{dc}Kₑ*G_{q}(θ_{dc}) (4)

The induced voltage coefficient Kₑ* 81 is a constant value and is not a data such as induced voltage that varies with rotational position. In addition, the calculation section 84 calculates d-axis voltage command value v_{dc0}* according to Formula 5 by using the electrical circuit parameters of the permanent magnet motor 1, such as the set value of winding resistance R*, the set value of q-axis inductance L_{q}*, the d-axis current command value i_{d}*, the q-axis current command value i_{q}*, frequency estimates ω_{dc}.

The output v_{dc0}* of arithmetic unit 84 is input to adder 85 together with the d-axis induced voltage command value e_{dc}*, and the output of adder 85 is the d-axis voltage command value reference value v_{dc}* shown in Formula 6.

$$\begin{matrix}[ Equation 5 ] & \\ {v}_{d c 0}^{*} = {R}^{*} {i}_{d}^{*} - {ω}_{d c} {L}_{q}^{*} \frac{1}{1 + Tacr s} {i}_{q}^{*} & ( 5 )\end{matrix}$$

$$\begin{matrix}[ Formula 6 ] & \\ {v}_{d c}^{*} = {v}_{d c 0}^{*} - {e}_{d c}^{*} & ( 6 )\end{matrix}$$

where T_{acr}: Response time constant of current control

Second, the q-axis voltage command value of vector control arithmetic unit 8 is explained.

The induced voltage coefficient Kₑ* 81 of permanent magnet motor 1 and the magnetic flux gain G_{d} (θ_{dc}) of the d-axis are input to multiplier 87.

The output of multiplier 87 is input to multiplier 88 together with frequency estimate ω_{dc}.

The output of multiplier 88 is the q-axis induced voltage command value e_{qc}* shown in Formula 7.

Here, frequency estimates ω_{dc} is used as the input of multiplier 88, but it can be modified so that frequency command value ωᵣ* is used as the input of multiplier 88 instead of frequency estimates ω_{dc} and multiplied with the output of multiplier 87.

[Formula 7]

e_{qc}*=ω_{dc}Kₑ*G_{d}(θ_{dc}) (7)

In addition, the calculation section 86 calculates the electrical circuit parameters of the permanent magnet motor 1 of winding resistance setting R*, d-axis inductance setting L_{d}*, d-axis current command value i_{d}*, q-axis current command value i_{q}*, frequency estimates ω_{dc} are used to calculate the q-axis voltage command value v_{qc0}* according to Formula 8.

The output v_{qc0}* of arithmetic unit 86 is input to adder 89 together with the q-axis induced voltage command value e_{qc}*. The output of adder 89 is the reference value v_{qc}* of the q-axis voltage command value shown in Formula 9.

$$\begin{matrix}[ Equation 8 ] & \\ {v}_{q c 0}^{*} = {R}^{*} {i}_{q}^{*} + {ω}_{d c} {L}_{d}^{*} \frac{1}{1 + Tacr s} {i}_{d}^{*} & ( 8 )\end{matrix}$$

$$\begin{matrix}[ Formula 9 ] & \\ {v}_{q c}^{*} = {v}_{q c 0}^{*} + {e}_{q c}^{*} & ( 9 )\end{matrix}$$

Third, the current control operation of the vector control is explained. d-axis and q-axis voltage correction values Δv_{dc} and Δv_{qc} are calculated according to Formula 10 by proportional control and integral control so that the current sense values i_{dc} and i_{qc} of each component follow the current command values i_{d}* and i_{q}* of the d and q axes, respectively.

$$\begin{matrix}[ Fromula 10 ] & \\ [ \begin{matrix}Δ {v}_{d c} = ( {K}_{pd} + \frac{{K}_{id}}{s} ) ( {i}_{d}^{*} - {i}_{d c} ) \\ Δ {v}_{q c} = ( {K}_{pq} + \frac{{K}_{iq}}{s} ) ( {i}_{q}^{*} - {i}_{q c} )\end{matrix} & ( 10 )\end{matrix}$$

### WHEREAS,

K_{pd}: proportional gain of current control of d-axis, K_{id}: integral gain of current control of d-axis
K_{pq}: proportional gain of q-axis current control, K_{iq}: integral gain of q-axis current control

In addition, the d-axis and q-axis voltage command value v_{dc}** and v_{qc}** are calculated according to Formula 11.

$$\begin{matrix}[ Fromula 11 ] & \\ [ \begin{matrix}{v}_{d c}^{**} = {v}_{d c}^{*} + Δ {v}_{d c} \\ {v}_{q c}^{**} = {v}_{qc}^{*} + Δ {v}_{qc}\end{matrix} ] & ( 11 )\end{matrix}$$

The phase error estimation unit 9 calculates the phase error estimates Δθ based on the d-axis and q-axis voltage command value v_{dc}**, v_{qc}**, current sense value i_{dc}, i_{qc} and the electrical circuit parameters of magnet motor 1 (R*, L_{q}*), frequency estimation ω_{dc} and the extended induced voltage formula (Formula 12).

$$\begin{matrix}[ Formula 12 ] & \\ Δ θ c = {tan}^{- 1} ( \frac{{v}_{d c}^{**} - {R}^{*} {i}_{d c} + {ω}_{d c} {L}_{q}^{*} {i}_{qc}}{{v}_{qc}^{**} - {R}^{*} {i}_{qc} - {ω}_{d c} {L}_{q}^{*} {i}_{d c}} ) & ( 12 )\end{matrix}$$

Frequency and phase estimation 10 will be described.

To make the phase error estimates Δθ_{c} follow the command value Δθ_{c}*, frequency estimates ω_{dc} are calculated according to Formula 13 by P(proportional)+I(integral) control operation, and phase estimates value θ_{dc} are calculated according to Formula 14 by I control operation.

$$\begin{matrix}[ Formula 13 ] & \\ {ω}_{d c} = ( {Kp}_{pll} + \frac{{Ki}_{pll}}{s} ) ( {Δθ}_{c}^{*} - {Δθ}_{c} ) & ( 13 )\end{matrix}$$

### WHEREAS,

Kpₚₗₗ: proportional gain of PLL control, Kiₚₗₗ: integral gain of PLL control

$$\begin{matrix}[ Formula 14 ] & \\ θ d c = \frac{1}{s} \cdot {ω}_{d c} & ( 14 )\end{matrix}$$

The principle of the sinusoidal motor current in the present invention is explained next.

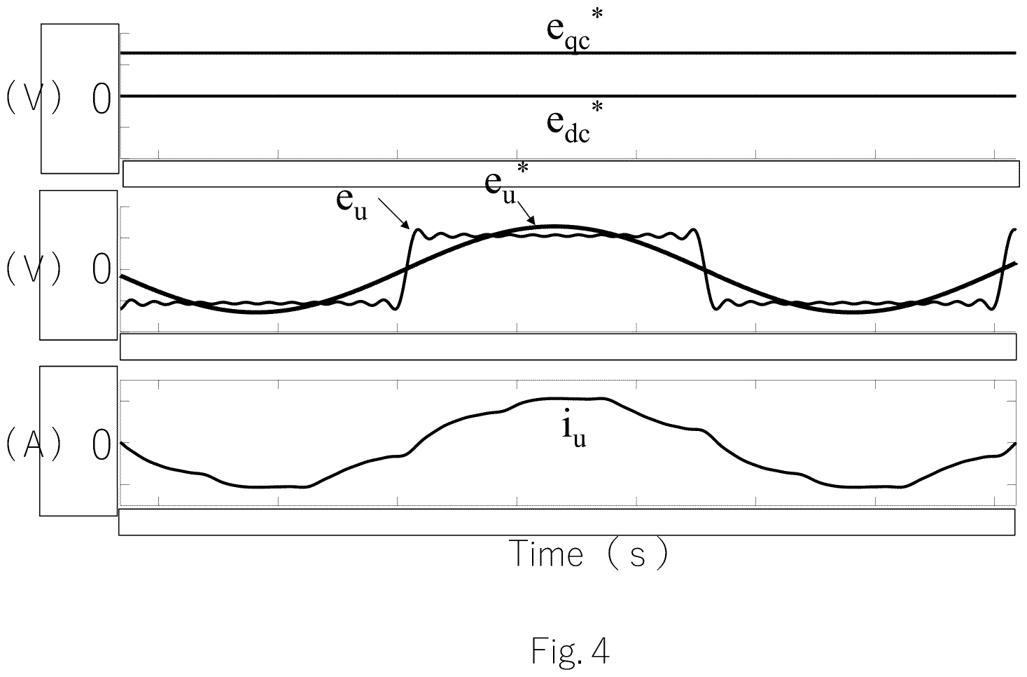

FIG. 4 shows control characteristic 1 when the d-axis and q-axis magnetic flux gains are G_{q} (θ_{dc})=0 and G_{d} (θ_{dc})=1, respectively. This is the simulation result of driving magnet motor 1 with square wave induced voltage.

In FIG. 4, the upper row displays the d-axis and q-axis induced voltage command value e_{dc}* and e_{qc}*, the middle row displays the square wave induced voltage eᵤ of phase u and the command value equivalent eᵤ* of the induced voltage of phase u, and the lower row displays the alternating current iᵤ of phase u. Since G_{q} (θ_{dc})=0 and G_{d} (θ_{dc})=1 the d-axis and q-axis induced voltage command values e_{dc}* and e_{qc}* are Formula 15 and eᵤ* is a sine wave.

$$\begin{matrix}[ Formula 15 ] & \\ \begin{matrix}{e}_{d c}^{*} = 0. \\ {e}_{qc}^{*} = {ω}_{d c} {K}_{e}^{*}\end{matrix} ) & ( 15 )\end{matrix}$$

As a result, the alternating current iᵤ of phase u is not a sinusoidal current, but a distorted current with superimposed 5th and 7th harmonics.

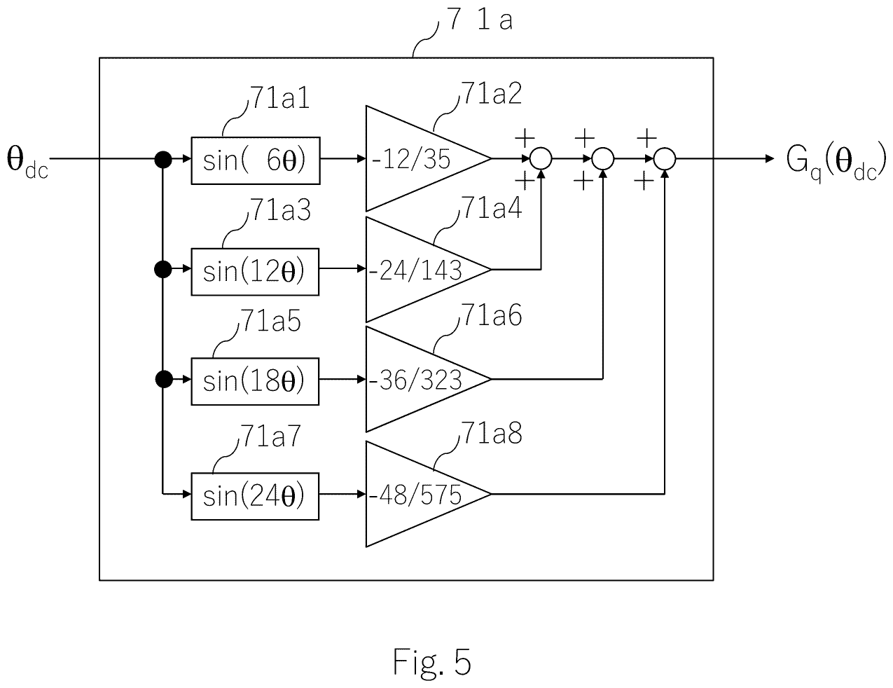

In using the magnetic flux gain calculation unit 7 of the present invention, the order N shown in Formula 2 is set to 4, for example. FIG. 5 shows the block (compensation up to the 24th harmonic) of the q-axis magnetic flux gain calculation unit 71a with N=4.

The phase of n=1 is calculated by 71a1 and the magnetic flux gain is calculated by 71a2. n=2 is calculated by 71a3 and the magnetic flux gain is calculated by 71a4. n=3 is calculated by 71a5 and the magnetic flux gain is calculated by 71a6. The phase of n=4 is calculated by 71a7 and the magnetic flux gain is calculated by 71a8. These are uniquely determined, and the signal obtained by adding the results of operations n=1 to n=4 is G_{q} (θ_{dc}).

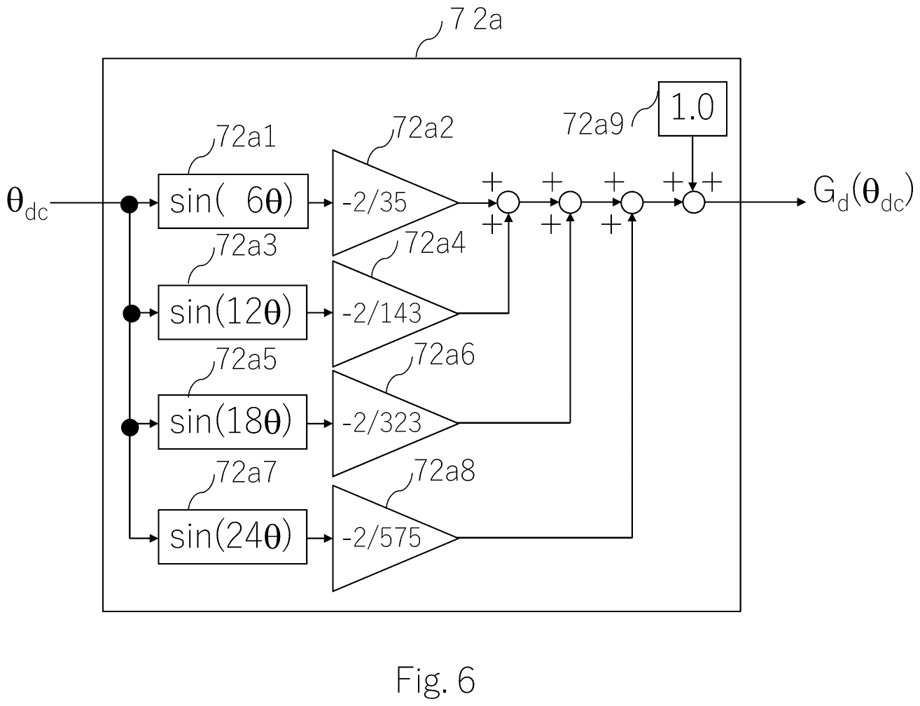

Next, set N=4 as shown in Formula 3. FIG. 6 shows the block diagram (compensation up to the 24th harmonic) of the d-axis magnetic flux gain calculation unit 72a set to N=4.

The phase of n=1 is calculated by 72a1 and the magnetic flux gain is calculated by 72a2. n=2 is calculated by 72a3 and the magnetic flux gain is calculated by 72a4. n=3 is calculated by 72a5 and the magnetic flux gain is calculated by 72a6. The phase of n=4 is calculated by 72a7 and the magnetic flux gain is calculated by 72a8. The constant “1” is set in the setting section 72a9. n=1 to n=4 and the constant “1” are added to obtain the signal G_{d} (θ_{dc}).

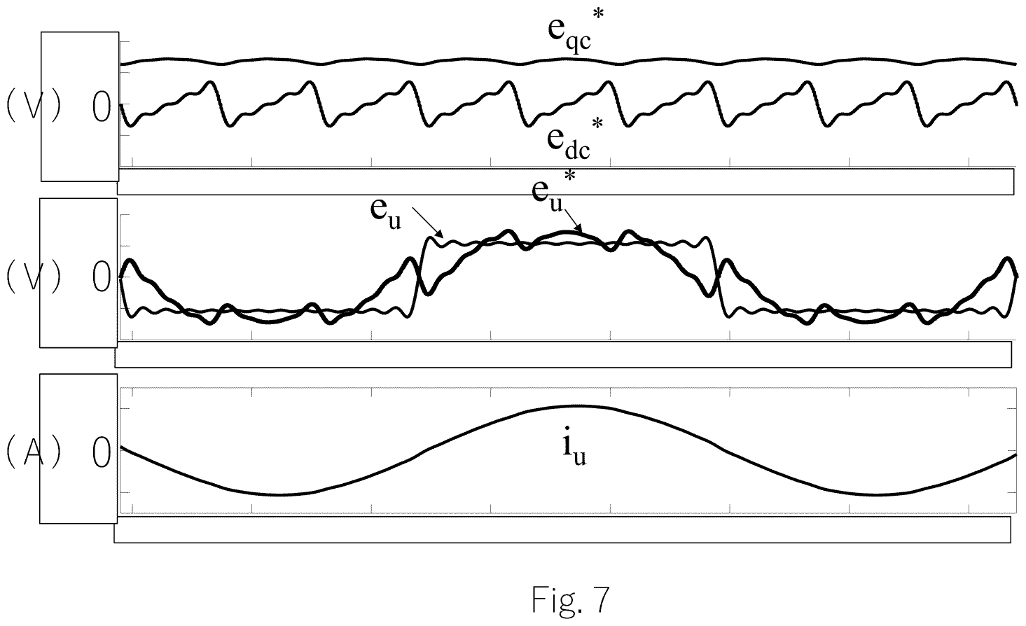

FIG. 7 shows the control characteristics 2 when magnetic flux gain calculation unit 7 is used (N=4 is used). This is the simulation result of driving magnet motor 1 whose induced voltage is a square wave.

In FIG. 7, the top row shows the d-axis and q-axis induced voltage command value e_{dc}* and e_{qc}*, the middle row shows the square wave induced voltage eᵤ of phase u and the command value equivalent eᵤ* of the induced voltage of phase u, and the bottom row shows the alternating current iᵤ of phase u.

G_{q} (θ_{dc}) is shown the block diagram in FIG. 5, G_{d} (θ_{dc}) shown in the block diagram in FIG. 6.

The d-axis and q-axis induced voltage command values e_{dc}* and e_{qc}* include up to 24th harmonic components, and the induced voltage command value equivalent eᵤ* is a waveform far from a sine wave containing harmonics, but the alternating current iᵤ is a sinusoidal current.

The effect of the invention is evident. In the case of FIG. 4, the d-axis induced voltage command value e_{dc}* is zero, but the d-axis induced voltage command value e_{dc}* is not zero as in FIG. 4, but has a shape that includes harmonic components (sawtooth wave). This is one of the characteristics.

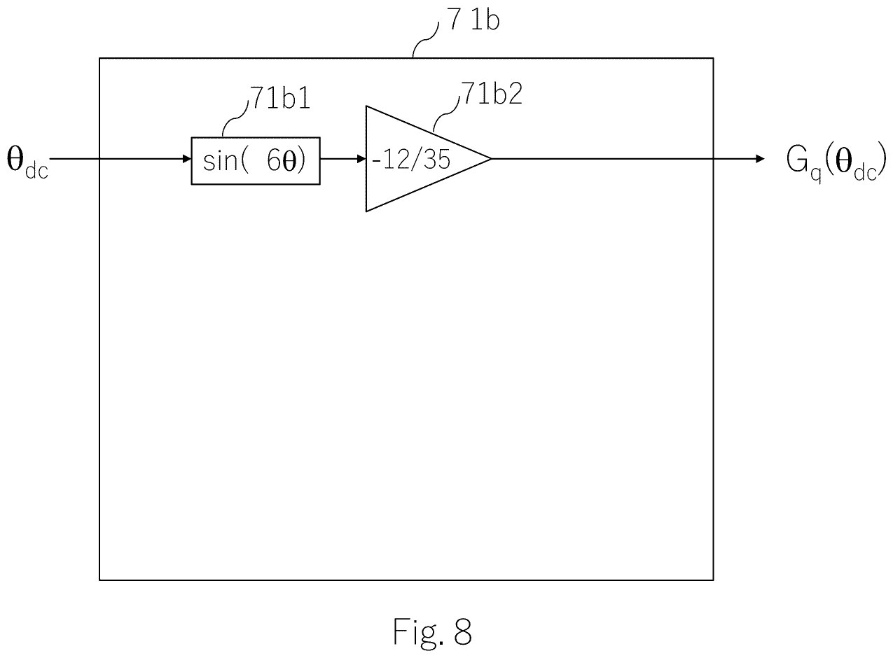

Furthermore, set N=1 in the magnetic flux gain calculation unit 7 in FIG. 1. (In Formula 2, set N=1. FIG. 8 shows the block of magnetic flux gain calculation unit 71b for the q-axis set to N=1 (compensation of 6th harmonic). n=1 phase is calculated in calculation unit 71b1 and magnetic flux gain is calculated in calculation unit 71b2. The signal is G_{q} (θ_{dc}).

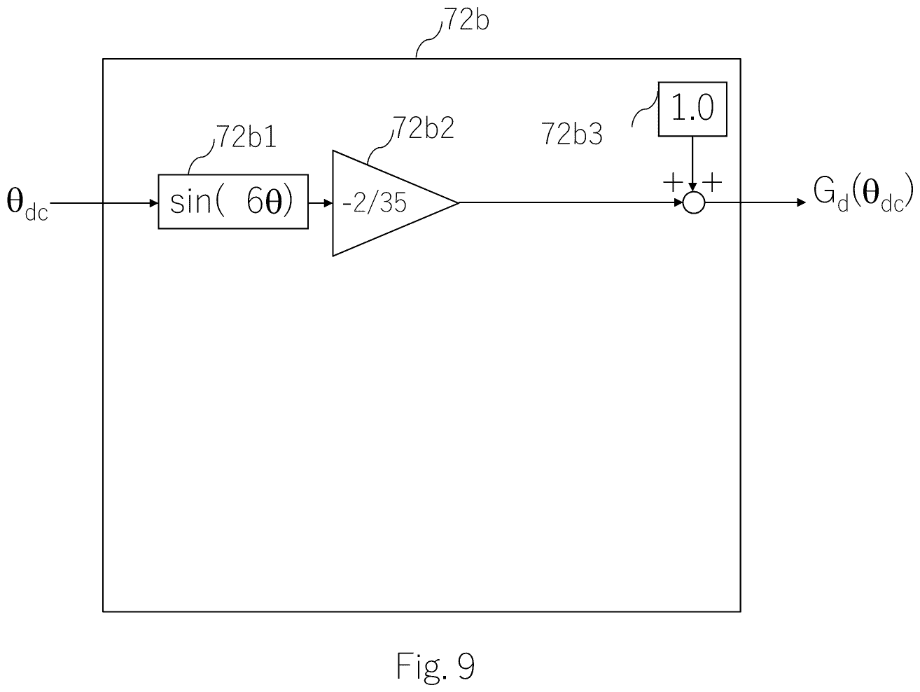

Next, set N=1 in Formula 3. FIG. 9 shows the block of the magnetic flux gain calculation unit 72b for the d-axis set to N=1 (compensation of 6th harmonic). n=1 phase is calculated in calculation unit 72b1 and magnetic flux gain in calculation unit 72b2. The constant “1” is set in the setting unit 72b3. The additive signal with constant “1” and n=1 is G_{d} (θ_{dc}).

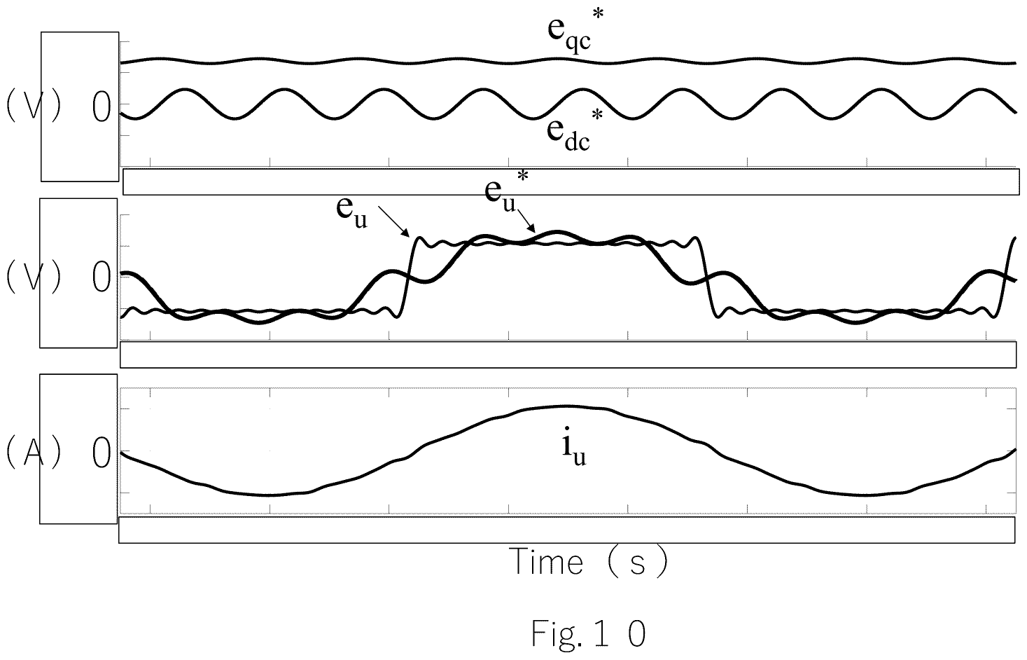

FIG. 10 shows the control characteristics 3 when the magnetic flux gain calculation unit 7 is used (N=1 is used). This is the simulation result of driving magnet motor 1 whose induced voltage is a square wave.

In FIG. 10, the upper row displays the d-axis and q-axis induced voltage command values e_{dc}* and e_{qc}*, the middle row displays the square wave induced voltage of phase u eᵤ and the command value equivalent eᵤ* of the induced voltage of phase u, and the lower row displays the alternating current iᵤ of phase u. G_{q} (θ_{dc}) is the block diagram in FIG. 8, G_{d} (θ_{dc}) is the case of the calculation in the block diagram in FIG. 9.

The d-axis and q-axis induced voltage command values e_{dc}* and e_{qc}* contain 6th harmonic components, and the induced voltage command value equivalent eᵤ * is far from a sinusoidal waveform, but the alternating current iᵤ of phase u is somewhat distorted compared to a sinusoidal waveform. The effect of this invention is obvious. To confirm the effect of this example, the order N was set to N=4 and N=1 as an example. N is a natural number, and the larger the value of N, the closer the alternating current of the u-phase can be to a sine wave.

According to this example, the current of magnet motor can be made sinusoidal without having induced voltage data by a general-purpose controller or other means.

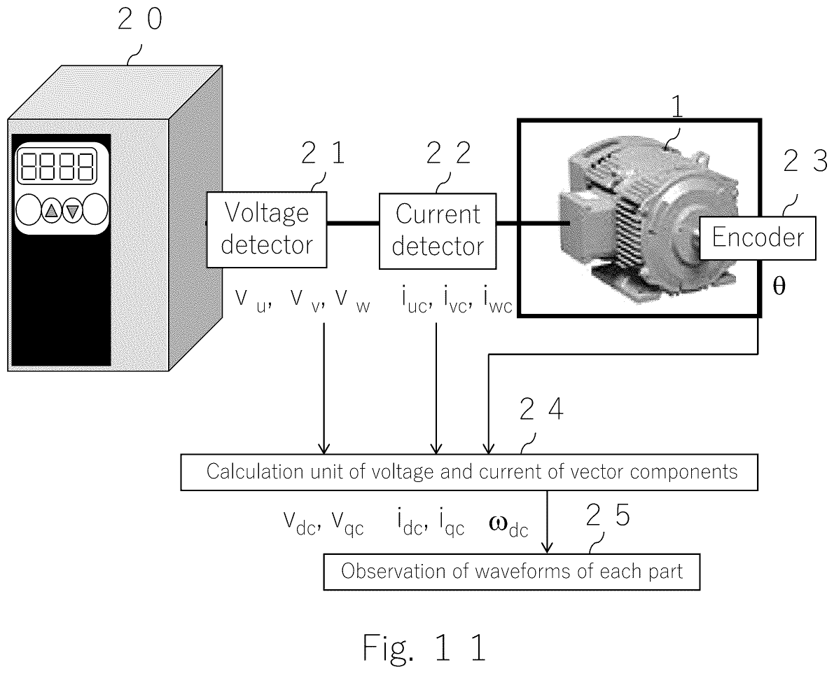

Here, the verification method when this example is adopted is explained using FIG. 11. voltage detector 21 and current detector 22 are attached to the power converter apparatus 20 that drives magnet motor 1, and encoder 23 is attached to the shaft of magnet encoder 23 is attached to the shaft of magnet motor 1.

The voltage detection values of 3-phase AC (v_{uc}, v_{vc}, v_{wc}) and current sense values of 3-phase AC (i_{uc}, i_{vc}, i_{wc}) which are outputs of voltage detector 21, and the position detection values θ, which are outputs of encoder, are input to the calculation section 24 for vector voltage and current components, V_{dcc}, v_{qcc}, i_{dcc} and i_{qcc} of the vector current components and the detected value ω_{rc}, which is the derivative of position θ, are calculated.

The observation section 25 of each part waveform calculates the d-axis and q-axis induced voltages e_{dc}\hat{ } and e_{qc}\hat{ } using Formula 16.

[Formula 16]

e_{dc}\hat{ }=v_{dcc}−(Ri_{dcc}−ω_{rc}L_{q}i_{qcc})

e_{qc}\hat{ }=v_{qcc}−(Ri_{qcc}+ω_{rc}L_{d}i_{dcc}) (16)

By observing the voltage waveforms of e_{dc}\hat{ } and e_{qc}\hat{ }, it is obvious that the invention has been adopted.

### EXAMPLE 2

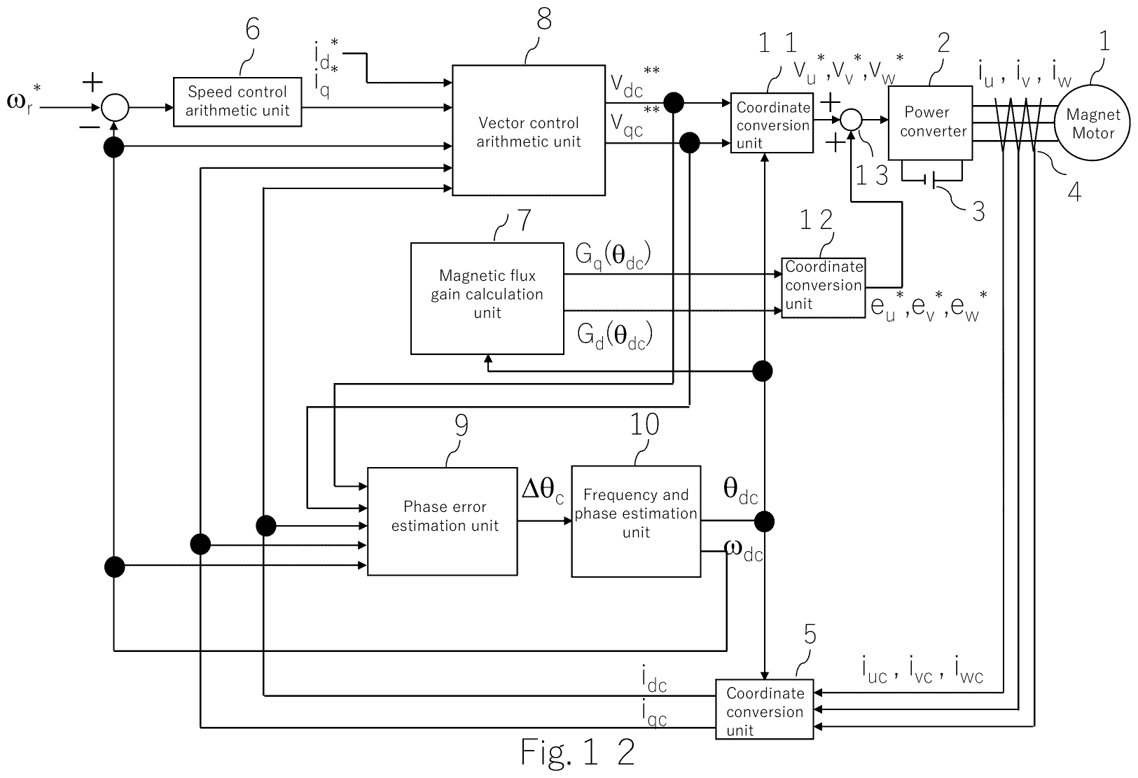

FIG. 12 shows the system configuration diagram with power converter apparatus and magnet motor in Example 2.

While Example 1 modified the d-q-axis voltage command value of the rotary seat coordinates, this example modifies the U-V-W voltage command value of the fixed coordinates.

In FIG. 12, magnet motor 1, power converter 2, DC power supply 3, current detector 4, coordinate conversion unit 5, speed control arithmetic unit 6, magnetic flux gain calculation unit 7, phase error estimation unit 9, frequency and phase estimation 10, and coordinate conversion unit 11 are the same as in FIG. 1. The vector control arithmetic unit 8 in FIG. 3 without the induced voltage coefficients Kₑ* 81, multiplier 82, multiplier 83, adder 85, multiplier 87, multiplier 88, and adder 89 is shown in FIG. 12. FIG. 12 shows the vector control arithmetic unit 8.

12 is the coordinate conversion unit from rotational coordinates to fixed coordinates and 13 is the adder. Coordinate conversion unit 12 replaces the operations in vector control arithmetic unit 8 in FIG. 3. magnetic flux gain G_{q} (θ_{dc}) and d-axis magnetic flux gain G_{d} (θ_{dc}) to calculate the d-axis and q-axis induced voltage command values e_{dc}* and e_{qc}*. Then, coordinate conversion unit 12 outputs three-phase induced voltage command values eᵤ*, eᵥ*, and e_{w}* from the d-axis and q-axis induced voltage command values e_{dc}*, e_{qc}* and the phase estimate value θ_{dc}.

In this example, the d-axis and q-axis induced voltage command values e_{dc}* and e_{qc}* are converted to 3-phase induced voltage command values eᵤ*, eᵥ*, and e_{w}* to modify the 3-phase voltage command values.

According to this example, a sinusoidal current can be realized as in Example 1.

### EXAMPLE 3

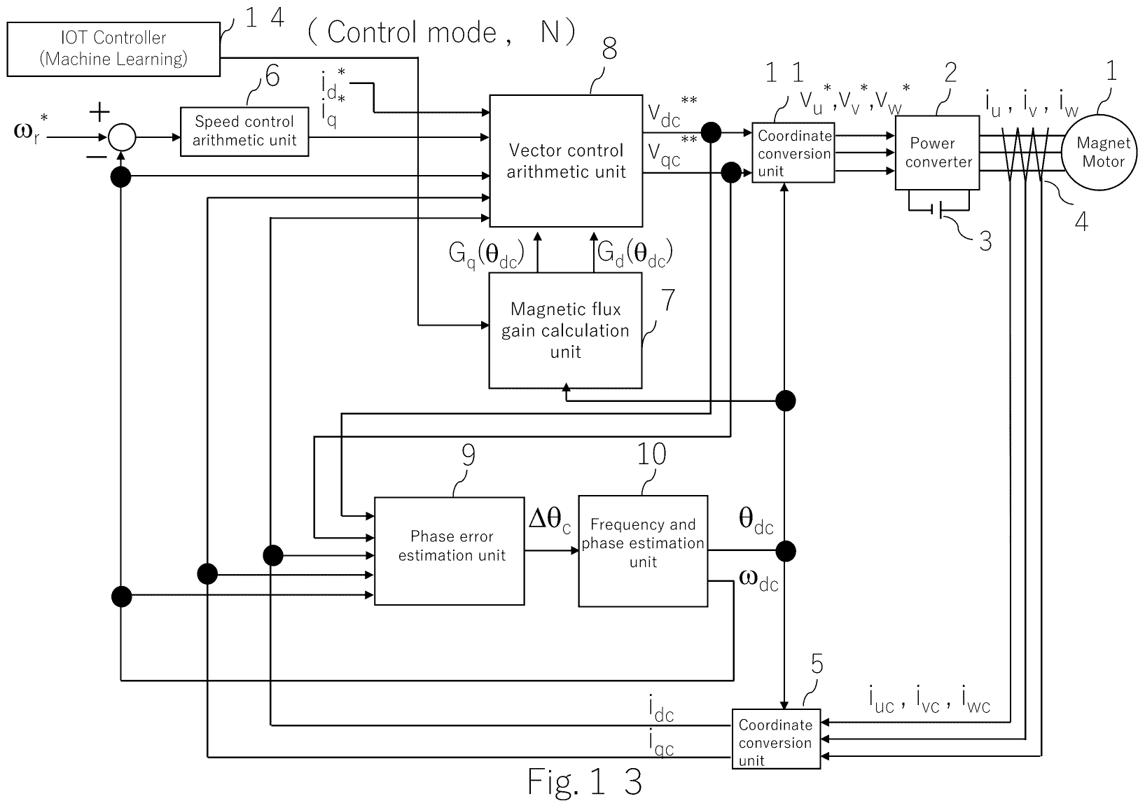

FIG. 13 is a system configuration diagram with power converter apparatus and magnet motor in Example 3. In FIG. 13, magnet motor 1, power converter 2, DC power supply 3, current detector 4, coordinate conversion unit 5, speed control arithmetic unit 6, magnetic flux gain calculation unit 7, vector control arithmetic unit 8, phase error estimation unit 9, frequency and phase estimation 10, and coordinate conversion unit 11 is identical to FIG. 1. 14 is an IOT(Internet of Things) controller that can perform machine learning.

Example 1 is a configuration in which the drive mode (square wave drive or sine wave drive) and parameters such as the order N of Formula 2 or Formula 3 are set in the controller (microcomputer or other control unit) of the power converter.

When the control unit in Example 3 receives an instruction for sinusoidal drive, it sets the gain of the q-axis flux component to 0 and the gain of the d-axis flux component to 1.

When a square wave drive instruction is received, the control unit calculates the gain of said magnetic flux component of the q-axis as a sine function of the phase estimate based on Formula 2. Furthermore, the control unit calculates the gain of the magnetic flux component of the d-axis as a sinusoidal function of the phase estimate based on Formula 3, and subtracts the result of the calculation from 1.

In this example, the control unit feeds back the voltage command value v_{dc}**, v_{qc}** and current sense value i_{dc}, i_{qc}, phase error estimates Δθ_{c} to the upper IOT CONTROLLER 14. IOT CONTROLLER 14 analyzes the signals such as voltage command value v_{dc}**, v_{qc}** and current sense value i_{dc}, i_{qc}, phase error estimates Δθ_{c} by machine learning, and based on the machine learning, the control unit re-sets the drive mode and order N to the power converter 2 controller.

According to this example, a sinusoidal current can be realized as in Example 1.

### Example 4

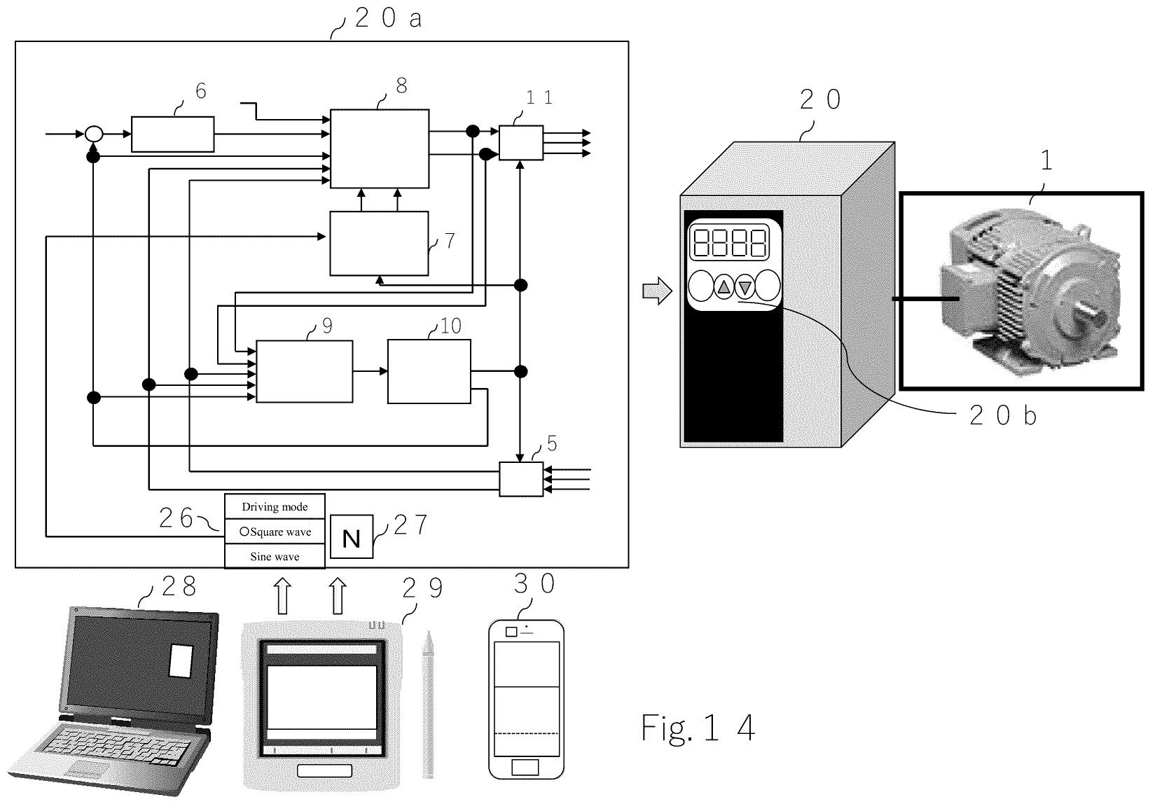

FIG. 14 shows the system configuration diagram with power converter apparatus and magnet motor in Example 4.

This example is the application of this system to a magnet motor drive system.

In FIG. 14, the components magnet motor 1, coordinate conversion unit 5, speed control arithmetic unit 6, magnetic flux gain calculation unit 7, vector control arithmetic unit 8, phase error estimation unit 9, frequency and phase estimation 10, and coordinate conversion unit 11 are identical to those in FIG. 1.

Magnet motor 1, a component of FIG. 1, is driven by power converter apparatus 20. Power converter apparatus 20 consists of coordinate conversion unit 5, speed control arithmetic unit 6, magnetic flux gain calculation unit 7, vector control arithmetic unit 8, vector control arithmetic unit 8, phase error estimation unit 9, frequency and phase estimation unit 10, and magnetic flux gain calculation unit 11. arithmetic unit 6, magnetic flux gain calculation unit 7, vector control arithmetic unit 8, phase error estimation unit 9, frequency and phase estimation 10 and coordinate conversion unit 11 are implemented as software 20a. The power converter apparatus 20 has the power converter 2, DC power supply 3, and current detector 4 of FIG. 1 implemented as hardware.

From the display screen of a higher-level device such as a digital operator 20b, personal computers 28, tablets 29, smartphones 30, etc., the “drive mode” 26 to set the square wave drive or sinusoidal drive of software 20a, Formula 2 and Formula 3, the “order N 27” can be set and changed.

If this example is applied to a magnet motor drive system, the current of magnet motor, which is a square wave induced voltage, can be controlled sinusoidally. The “drive mode” and “N” may be set on a field bus such as a programmable logic controller, a local area network connected to a computer, or an IOT CONTROLLER.

The calculation results in the calculation sections 71a2, 71a4, 71a6, 71a8 of the magnetic flux gain in FIG. 5 and the calculation sections 72a2, 72a4, 72a6, 72a8 in FIG. 6 in Example 1 are constants, but these constants may be rewritten.

So far, in Examples 1 through 4, we have applied this method to position sensor-less control, but it can also be applied to vector control with an encoder attached to the shaft axis of magnet motor 1.

Furthermore, in Examples 1 through 4, voltage correction values Δv_{dc} and Δv_{qc} were created from current command value i_{d}*, i_{q} * and current sense value i_{dc}, i_{qc}, and the operation shown in Formula 11 was performed to add this voltage correction value and the voltage reference value for vector control. Not only that, from current command value i_{d}*, i_{q}* and current sense value i_{dc}, i_{qc}, the intermediate current command value i_{d}**, i_{q}** shown in Formula 17 used for vector control calculation were created, and frequency estimates ω_{dc} and the vector control operation shown in Formula 18 may be performed using the electrical circuit parameters of magnet motor 1.

$$\begin{matrix}[ Formula 17 ] & \\ \begin{matrix}{i}_{d}^{**} = ( {K}_{pd 1} + \frac{{K}_{id 1}}{s} ) ( {i}_{d}^{*} - {i}_{d c} ) \\ {i}_{q}^{**} = ( {K}_{pq 1} + \frac{{K}_{iq 1}}{s} ) ( {i}_{q}^{*} - {i}_{q c} )\end{matrix} & ( 17 )\end{matrix}$$

$$\begin{matrix}[ Formula 18 ] & \\ [ \begin{matrix}{v}_{d c}^{** *} = {R}^{*} {i}_{d}^{**} - {ω}_{d c} {L}_{q}^{*} \frac{1}{1 + {T}_{q} s} {i}_{q}^{**} \\ {v}_{q c}^{** *} = {R}^{*} {i}_{q}^{**} + {ω}_{d c} {L}_{d}^{*} \frac{1}{1 + {T}_{d} s} {i}_{d}^{**} + {ω}_{d c} {Ke}^{**}\end{matrix} ] & ( 18 )\end{matrix}$$

### WHEREAS,

K_{pd1}: proportional gain of current control of d_{c} axis,
K_{id1}: integral gain of current control of d_{c} axis, K_{pq1}: proportional gain of current control of q_{c} axis, K_{iq1}: integral gain of current control of q_{c} axis, T_{d}: electrical time constant of d axis (L_{d}/R), T_{q}: electrical time constant of q axis (L_{q}/R)

Alternatively, from the current command value i_{d}* and i_{q}* and the current sense value i_{dc} and i_{qc}, the voltage correction values Δv_{d_p}* for the proportional component of d-axis, Δv_{d_i}* for the integral component of d-axis, Δv_{q_p}* for the proportional component of q-axis and the modified values Δv_{q_i}* of the integral component of the q-axis are created using Formula 19.

Then, the vector control operation shown in Formula 20 using the frequency estimates ω_{dc} and the electrical circuit parameters of magnet motor 1 may be performed.

$$\begin{matrix}[ Formula 19 ] & \\ [ \begin{matrix}\begin{matrix}\begin{matrix}Δ {v}_{d \_ p}^{*} = {K}_{pd 2} ( {i}_{d}^{*} - {i}_{d c} ) \\ Δ {v}_{d \_ i}^{*} = \frac{{K}_{id 2}}{s} ( {i}_{d}^{*} - {i}_{d c} )\end{matrix} \\ Δ {v}_{q \_ p}^{*} = {K}_{pq 2} ( {i}_{q}^{*} - {i}_{q c} )\end{matrix} \\ Δ {v}_{q \_ i}^{*} = \frac{{K}_{iq 2}}{s} ( {i}_{q}^{*} - {i}_{q c} )\end{matrix} ] & ( 19 )\end{matrix}$$

### WHEREAS,

K_{pd2}: proportional gain of d-axis current control, K_{id2}: integral gain of d-axis current control, K_{pq2}: proportional gain of q-axis current control, K_{iq2}: integral gain of q-axis current control

$$\begin{matrix}[ Formula 20 ] & \\ [ \begin{matrix}{v}_{d c}^{** **} = ( Δ {v}_{d \_ p}^{*} + Δ {v}_{d \_ i}^{*} ) - {ω}_{d c} \frac{{L}_{q}^{*}}{{R}^{*}} Δ {v}_{q \_ i}^{*} \\ {v}_{q c}^{** **} = ( Δ {v}_{q \_ p}^{*} + Δ {v}_{q \_ i}^{*} ) + {ω}_{d c} \frac{{L}_{d}^{*}}{{R}^{*}} Δ {v}_{d\_i}^{*} + {ω}_{d c} {K}_{e}^{*}\end{matrix} ] & ( 20 )\end{matrix}$$

The primary delay signal i_{qctd} of the d-axis current command value i_{d}* and q-axis current sense value i_{qc}, frequency estimates ω_{dc} and the electrical circuit parameters of magnet motor 1 may be used to perform the vector control operation shown in Formula 21.

$$\begin{matrix}[ Formula 21 ] & \\ [ \begin{matrix}{v}_{d c}^{** ** *} = {R}^{*} {i}_{d}^{*} - {ω}_{d c} {L}_{q}^{*} {i}_{qctd} \\ {v}_{q c}^{** ** *} = {R}^{*} {i}_{qctd} + {ω}_{d c} {L}_{d}^{*} {i}_{d}^{*} + {ω}_{d c} {Ke}^{**}\end{matrix} ] & ( 21 )\end{matrix}$$

In Examples 1 to 4, the switching device that constitutes power converter 2 may be a Si(silicon) semiconductor device or a wide bandgap semiconductor device such as SiC(silicon carbide) or GaN(gallium nitride).

### REFERENCE SIGNS LIST

1 . . . magnet motor
2 . . . power converter
3 . . . DC power supply
4 . . . current detector
5 . . . coordinate conversion unit
6 . . . speed control arithmetic unit
7 . . . magnetic flux gain calculation unit
8 . . . vector control arithmetic unit
9 . . . phase error estimation unit
10 . . . frequency and phase estimation
11 . . . coordinate conversion unit
12 . . . coordinate conversion unit
13 . . . Addition section, Adder
14 . . . IOT controller
20 . . . power converter apparatus
20a . . . power converter apparatus software
20b . . . digital operator of power converter apparatus
21 . . . voltage detector
22 . . . current detector
23 . . . encoder
24 . . . calculation part of vector current component
25 . . . observation of current waveforms of each part
26 . . . control mode
27 . . . N (degree)
28 . . . personal computers
29 . . . tablet
30 . . . smartphones
i_{d}* . . . d-axis current command value
i_{q}* . . . q-axis current command value
ωᵣ* . . . frequency command value
ω_{dc} . . . frequency estimates
ωᵣ . . . magnet motor frequency
G_{q} (θ_{dc}) . . . q-axis magnetic flux component gain
G_{d} (θ_{dc}) . . . d-axis magnetic flux component gain
e_{dc}* . . . d-axis induced voltage command value
e_{dc}* . . . q-axis induced voltage command value
v_{dc}* v_{dc}** v_{dc}** v_{dc}*** v_{dc}**** v_{dc}***** . . . d-axis voltage command value
v_{qc}* v_{qc}** v_{qc}*** v_{qc}**** v_{qc}***** . . . q-axis voltage command value
Δθ_{c} . . . phase error estimates

1. A power converter apparatus comprising:
a power converter that outputs signal to the magnet motor to vary the output frequency, output voltage and output current of the magnet motor,
a control unit controls the power converter,
wherein the control unit
calculating the gain of the magnetic flux component of the q-axis, which varies with the phase of the magnet motor, calculating the d-axis induced voltage command value based on a value of the induced voltage coefficient, frequency estimates or frequency command value, and the gain of the flux component of the q-axis.

2. A power converter apparatus according to claim 1,
the control unit is calculating the gain of the magnetic flux component of the d-axis, which varies with the phase of the magnet motor,
calculating the q-axis induced voltage command value based on the set value of the induced voltage coefficient, frequency estimates or frequency command value, and the gain of the d-axis magnetic flux component.

3. A power converter apparatus according to claim 1,
the control unit is calculating the command values of the induced voltages of the three phases based on the command values of the induced voltages of the d-axis and the phase estimate value.

4. A power converter apparatus according to claim 2,
the control unit is calculating the command values of the induced voltages of the three phases based on the command value of the induced voltage of the d-axis, the command value of the induced voltage of the q-axis, and the phase estimate value.

5. A power converter apparatus according to claim 1,
the control unit is calculating the gain of said flux component of the q-axis as a sine function of the phase estimate value.

6. A power converter apparatus according to claim 2,
the control unit is calculating the gain of said flux component of the d-axis as a sine function of the phase estimate value,
and subtracting the result from 1.

7. A power converter apparatus according to claim 2,
the control unit is,
receiving instructions on whether the magnet motor is to be driven by a sinusoidal or square wave drive,
when the instruction indicating a sinusoidal drive, the gain of said flux component of the q-axis is set to 0 and the gain of said flux component of the d-axis is set to 1,
when the instruction indicating drive square wave drive, obtaining the gain of said flux component of the q-axis by computing as a sine function of the phase estimate value, and
obtaining the gain of said flux component of the d-axis by computing as a sine function of the phase estimate and subtracting the result of that calculation from 1.

8. A power converter apparatus according to claim 2,
when the magnet motor is directed to select a square wave drive,
the control unit is,
selecting the order N in the sinusoidal function of the phase estimate value,
calculating the gain of said flux component in the q-axis and the gain of said flux component in the d-axis based on said order N.

9. A power converter apparatus according to claim 2,
the control unit is,
being fed back voltage command value, current sense value, phase error estimates and estimated frequency to the host device for analysis,
automatically sets the order N in the sinusoidal function of the phase estimate value required to calculate the gain of said flux component in the q-axis or the gain of said flux component in the d-axis, based on analysis result from the host device.

10. A power converter apparatus according to claim 1,
the control unit is,
receiving direction of the order N in the sinusoidal function of the phase estimate required to calculate the gain of the flux component of the q-axis or the flux component of the d-axis,
or whether the magnet motor is driven sinusoidally or square wave from digital operators or personal computers, setting and changing control based on the direction.
